(19) United States
(12) Patent Application Publication
(10) Pub. No.: US 2010/0199008 A1
(43) Pub. Date: Aug. 5, 2010

(54) System and method for implementing a remote input device using virtualization techniques for wireless device

(76) Inventors: Kwang Wee Lee, Singapore (SG); Leandro Quitalig Galvez, Singapore (SG)

Correspondence Address: MILBANK, TWEED, HADLEY & MCCLOY, 1 CHASE MANHATTAN PLAZA, NEW YORK, NY, 10005-1413, US

(21) Appl. No.: 12/386,210

(22) Filed: Apr. 14, 2009

Related U.S. Application Data
(60) Provisional application No. 61/206,454, filed on Jan. 30, 2009.
(60) Provisional application No. 61/206,427, filed on Jan. 30, 2009.
(60) Provisional application No. 61/206,797, filed on Feb. 4, 2009.

(51) Int. Cl. G06F 13/00

(52) U.S. Cl. 710/110; 711/102; 711/104

(57) ABSTRACT

Systems and methods for implementing a remote input device using virtualization techniques for wireless devices are described. In one aspect, the system may comprise a wireless device that includes a processor, a memory, input hardware, and a protocol slave adapted to communicate with the input hardware; and a removable media device that includes a memory, a processor, and a protocol master adapted to communicate with the protocol slave of the wireless device. In another embodiment, the method may comprise emulating a hardware interface on a removable media device; mapping input hardware of a wireless device to the interface; mapping a processor of the media device to the input hardware; wrapping and sending input hardware commands from a protocol master of the media device to a protocol slave of the wireless device; and executing the commands on the input device.

### CROSS-REFERENCE TO RELATED APPLICATIONS

This application claims priority to U.S. Provisional Patent Applications Ser. Nos. 61/206,454, 61/206,453, and 61/206,427, filed Jan. 30, 2009, and U.S. Provisional Patent Application Ser. No. 61/206,797, filed Feb. 4, 2009, the disclosures of which are incorporated herein by reference.

### FIELD OF THE INVENTION

The present invention relates to a system and method for implementing a remote input device using virtualization techniques for wireless devices.

### BACKGROUND OF THE INVENTION

Current wireless device designs function with all the software layers residing in the handset, utilizing the main processor and attached radio hardware. The application and runtime environments are dependent on the hardware architecture of each specific handset. User applications and run-time environments on each handset lose portability and compatibility if the user were to change to a handset with some hardware architecture changes.

It may be desirable to have a system and method for implementing a remote input device using virtualization techniques for wireless devices. This makes the runtime environment and application independent of the input device hardware that is implemented on the wireless device. The removable media device with the processor and installed software can be connected to any other wireless device with a different input device hardware configuration and still function properly.

### SUMMARY OF THE INVENTION

Embodiments of the present invention may provide a method and system that may include a remote processor package housed in removable media accessing input device hardware in a wireless device, wherein the access takes place via a communication link. In one aspect, the present invention may provide for a remote processor package system housed in removable media.

In one aspect, the system may comprise a wireless device that includes a processor, a memory, input hardware, and a protocol slave adapted to communicate with the input hardware; and a removable media device that includes a memory, a processor, and a protocol master adapted to communicate with the protocol slave of the wireless device. In another embodiment, the method may comprise emulating a hardware interface on a removable media device; mapping input hardware of a wireless device to the interface; mapping a processor of the media device to the input hardware; wrapping and sending input hardware commands from a protocol master of the media device to a protocol slave of the wireless device; and executing the commands on the input device.

### BRIEF DESCRIPTION OF THE DRAWINGS

Features and other aspects of embodiments of the present invention are explained in the following description taking in conjunction with the accompanying drawings, wherein:

FIG. 1 illustrates a radio modem control block diagram for a typical wireless handset;

FIG. 2 illustrates a wireless device control block diagram with a processor and software applications according to one aspect of the system and method of the present disclosure;

FIG. 3 illustrates a wireless device design with a single controller device and microcode according to one aspect of the system and method of the present disclosure;

FIG. 4 illustrates a second control block diagram of a wireless device design with a single controller device and microcode according to one aspect of the system and method of the present disclosure;

FIG. 5 illustrates a removable media device design with the VID System implemented using a single device driver module containing the VID Device Driver, VID Core, and VID Protocol Master according to one aspect of the system and method of the present disclosure;
FIG. 6 illustrates a removable media device design with the VID System implemented using a device driver module and an application, with the VID Core and VID Protocol Master implemented in the application layer and the VID Device Driver in the device driver module according to one aspect of the system and method of the present disclosure;

FIG. 7 illustrates a flowchart for detecting configurable and non-configurable properties of the input device(s) on a wireless device according to one aspect of the system and method of the present disclosure;

FIG. 8 illustrates a flowchart for run-time configuration of the input device(s) properties of a wireless device according to one aspect of the system and method of the present disclosure;

FIG. 9 illustrates a flowchart for transferring input device event data from the removable media device to the wireless device according to one aspect of the system and method of the present disclosure; and

FIG. 10 illustrates a block diagram of the removable media device hardware design according to one aspect of the system and method of the present disclosure.

### DETAILED DESCRIPTION

Various embodiments of the present invention will now be described in greater detail with reference to the drawings.

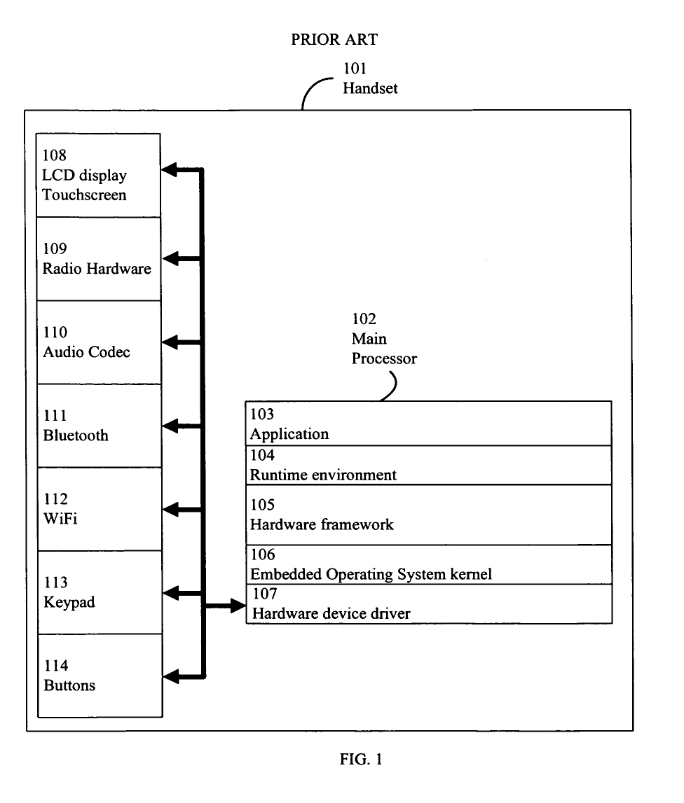

As shown in FIG. 1, typical architecture for a wireless handset 101 includes a processor 102 located in the handset 101. The current wireless handset design 101 has all the software layers stored in the handset 101, using the main processor 102 and attached input hardware such as a touchscreen 108, a keypad 113, or buttons 114. Current wireless handset design 101 includes the software layers for the application 103, the runtime environment 104, the wireless radio (GSM, CDMA, GPRS), WiFi, Bluetooth, camera, audio codec, and GPS hardware framework 105, and the embedded operating system kernel 106 located entirely in the wireless handset 101. Additionally, current wireless handset design 101 includes hardware device drivers 107 connected to an LCD display or touch screen 108, radio hardware 109, an audio codec 110, Bluetooth 111, WiFi 112, a keypad 113, and buttons 114. Input devices, may include a keypad 113, touchscreen 108, buttons 114.

This disclosure describes the invention of a system and method where the input device hardware of a wireless device may be remotely controlled from a removable media device with processing capability. In one aspect, implementing a Virtual Input Device (VID) on the operating system of the removable media device may allow remote control of input device hardware of a wireless device. In further aspects, the VID may allow for the physical input device be processed and controlled remotely from the removable media that may run applications.

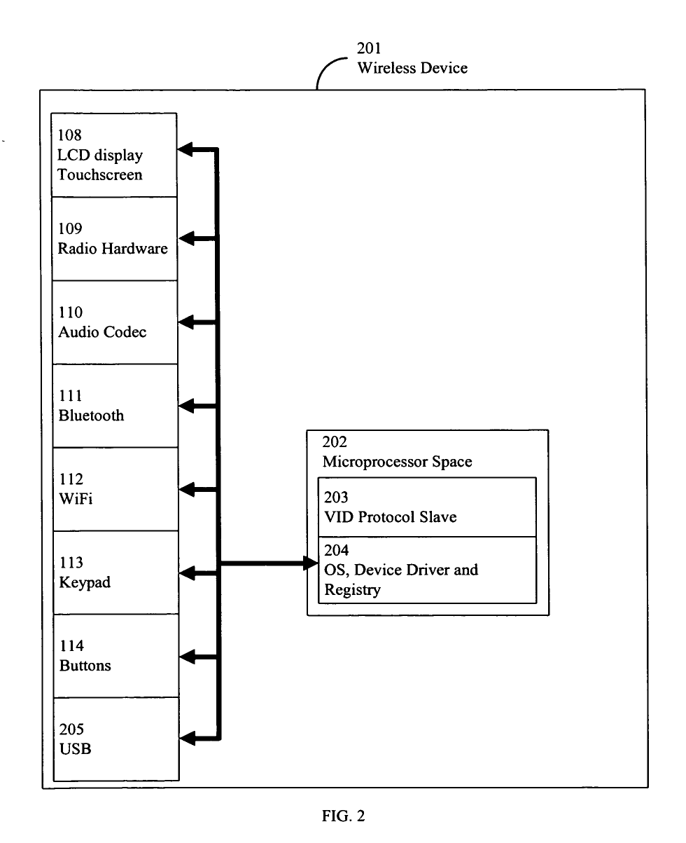

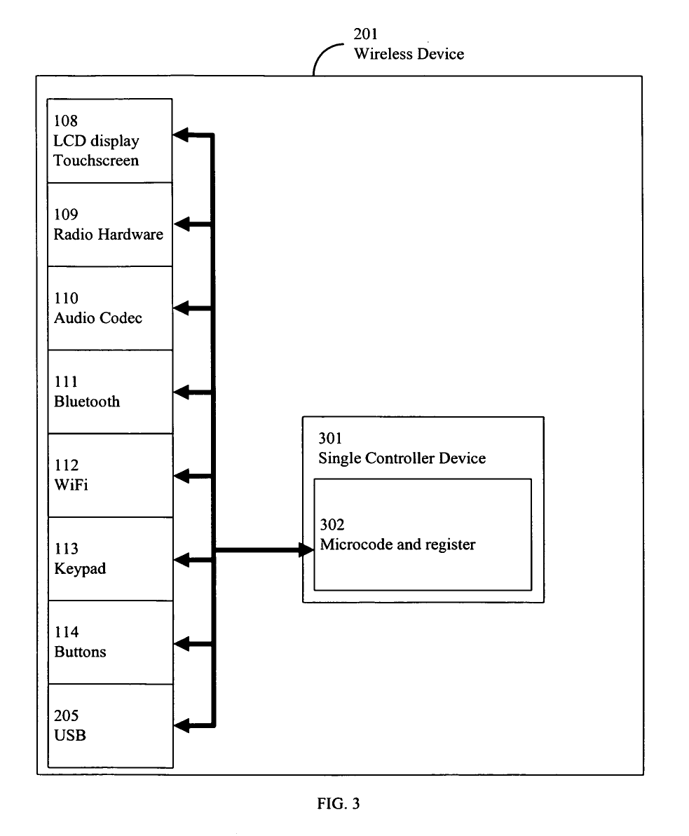

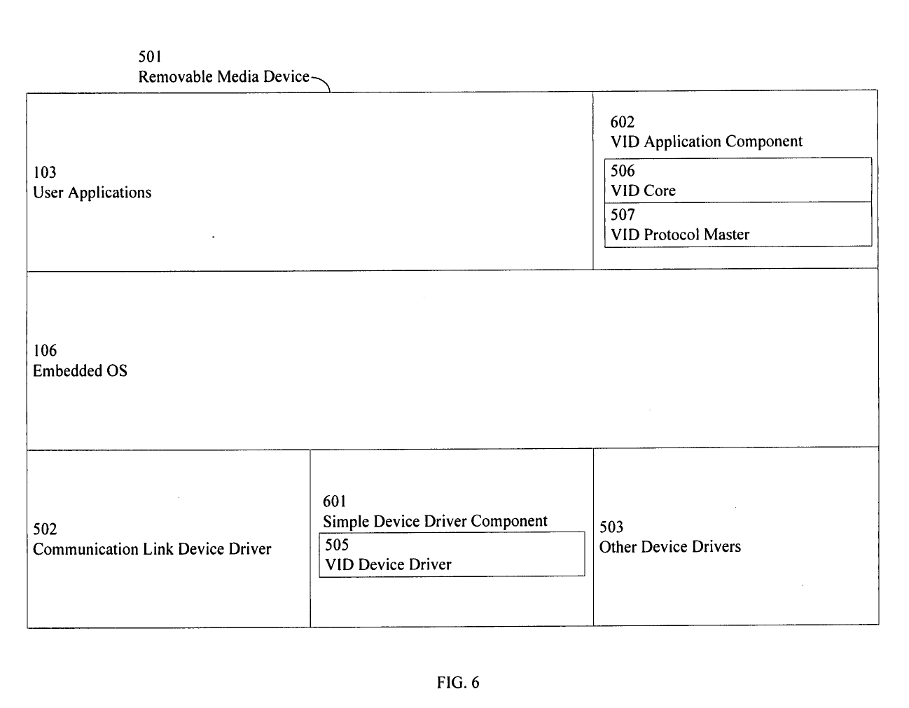

FIG. 2 illustrates a wireless device control block diagram with a VID System implemented with hardware and software according to one aspect. FIG. 3 illustrates a wireless device design with a VID System implemented in hardware according to another aspect. FIGS. 2 and 3 illustrate various aspects in implementing a wireless device according to the amount of hardware and software implemented. FIG. 5 illustrates a removable media device design with the VID System implemented using a single device driver module containing the VID Device Driver, VID Core, and VID Protocol Master according to a further aspect. FIG. 6 illustrates a removable media device design with the VID System implemented using a device driver module and an application, with the VID Core and VID Protocol Master implemented in the application layer and the VID Device Driver in the device driver module according to another aspect. FIGS. 5 and 6 illustrate other aspects for implementing the removable media device software stack. The software stack may be implemented in many ways, including the implementations illustrated in FIGS. 5 and 6.

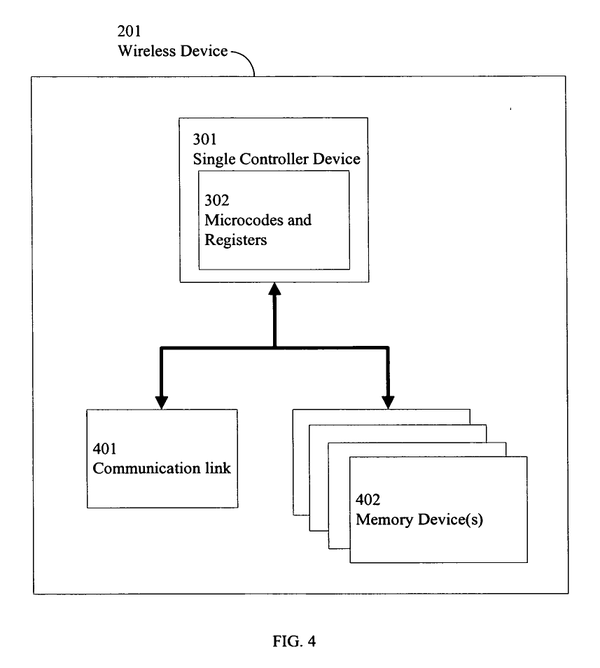

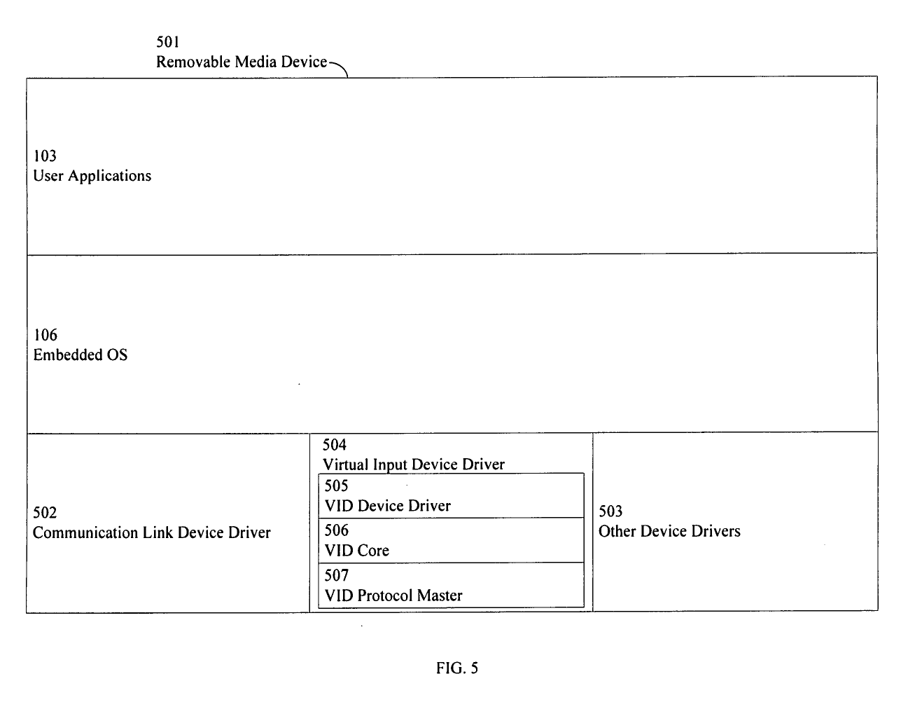

FIG. 4 illustrates one aspect of the removable media device hardware design. In this aspect, the communication link 401 may be a bus, such as USB, high-speed digital data bus, or other removable card format bus. In other aspects, communication link 401 may be a wireless connection. In a further aspect, the single controller device may also communicate with one or more memory devices 402.

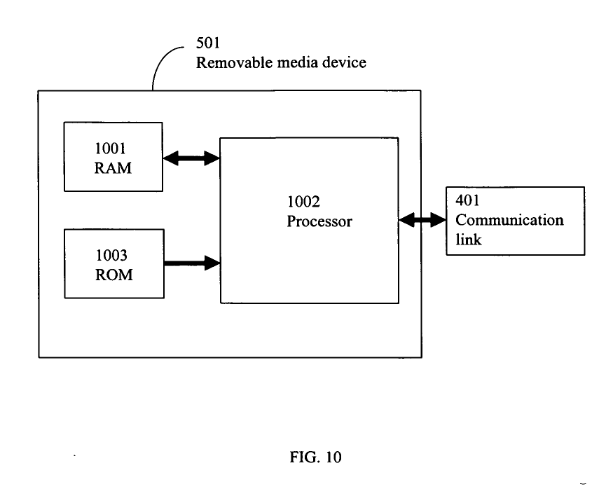

FIG. 10 illustrates a removable media device 501 in this context comprising a system with processing power comprised of processor(s) 1002, RAM 1001, ROM 1003, a communication link 401 and embedded software packaged in form factors such as but not limited to USB dongle, SIM, SAM, SD, and other memory cards.

Embodiments of this invention are the designs of VID systems that enable input device data from the wireless device 201 to be delivered to the removable media device 501 and controlled remotely with configurable capabilities such as but not limited to thresholds, min values, max values, character case, and language from the removable media device 501. The removable media device 501 can be packaged in the form of USB dongle, SIM, SAM, SD, or other memory cards and may be removable from the wireless device 201. The removable media device 501 is connected to the wireless device 201 via a communication link 401, such as USB or any removable card format bus. In further aspects, the communication link 401 may be wireless. The OS 106 and the application 103 on the removable media device 501 can process and control the input data and the configuration of the physical input device on the wireless device 201 using this technique.

The VID system is comprised of three components, VID Protocol 507 that handles exchange of data and control signals, a VID Core 506 that may process data and control signals, and a VID Device Driver 505 that interfaces with the embedded operating system kernel 106 providing the API's required by the kernel 106. The VID Protocol may be further divided into two parts, one for the VID Protocol Master 507 residing on the removable media device 501 where the input data may be processed and one protocol slave 203 residing on the wireless device 201 where input data is gathered.

### Wireless Device Requirements

FIG. 2 and FIG. 3 illustrate various embodiments of the wireless device. In one aspect, the wireless device 201 may be required to be able to communicate with the removable media device 501 using a communication link 401, be able to understand the VID Protocol, be able to process control signals for the VID Protocol, be able to gather the input event data from the input devices and send them over the protocol. In FIG. 2, the VID System is implemented with hardware and software using a VID Protocol Slave 203 and an OS, device driver and registry 204 in a microprocessor space 202. The registry may store the configurable and non-configurable properties of the wireless device. In another aspect, the wireless device may include USB 205. FIG. 2 illustrates a system comprised of hardware and software to achieve the requirements while FIG. 3 shows a system using a full hardware design that can handle the whole wireless device system including the handling of the VID Protocol using microcode and registers 302 or pure hardware logic in a single controller device 301 to process the protocol. In further aspects, microcode may be hardware programming logic used in design with FPGA and ASIC hardware. Microcode may allow implementing a hardware transistor design using program coding. In another aspect, registers may store the capability and configuration of the input devices present on the wireless device 201.

### Removable Media Device Requirements

FIG. 5 and FIG. 6 illustrate various embodiments of the removable media device. The removable media device 501 may be required to be able to communicate with the wireless device 201 using a communication link 401.

The removable media device 501 may require an operating system 106 or core logic for controlling the program flow and data flow in the system, a device driver 502 to control the communication link 401 to the wireless device 201, a device driver system for the VID which may emulate the existence of input device(s) for the removable media device 501 from the point of view of the OS 106. FIG. 5 illustrates an implementation where the VID driver system is implemented using a single module in the device driver layer 504. One or more other device drivers 503 may also be present in the device driver layer. FIG. 6 illustrates an implementation where the VID driver system is implemented using a mixture of application layer 602 and device driver layer 601 modules. The VID Device Driver 505 in FIG. 6 may offer the driver API to the operating system 106 and allow for insertion of input event data.

FIG. 5 shows simpler software stack as the entire VID driver system is implemented purely in device driver layer 504. FIG. 6 shows more complex but more manageable software stack as most of its logic and data control, which may include the VID Core 506 and VID Protocol Master 507 are implemented in the user space application layer 602 allowing for easy update of the stack.

### Detecting Configurable and Non-Configurable Properties

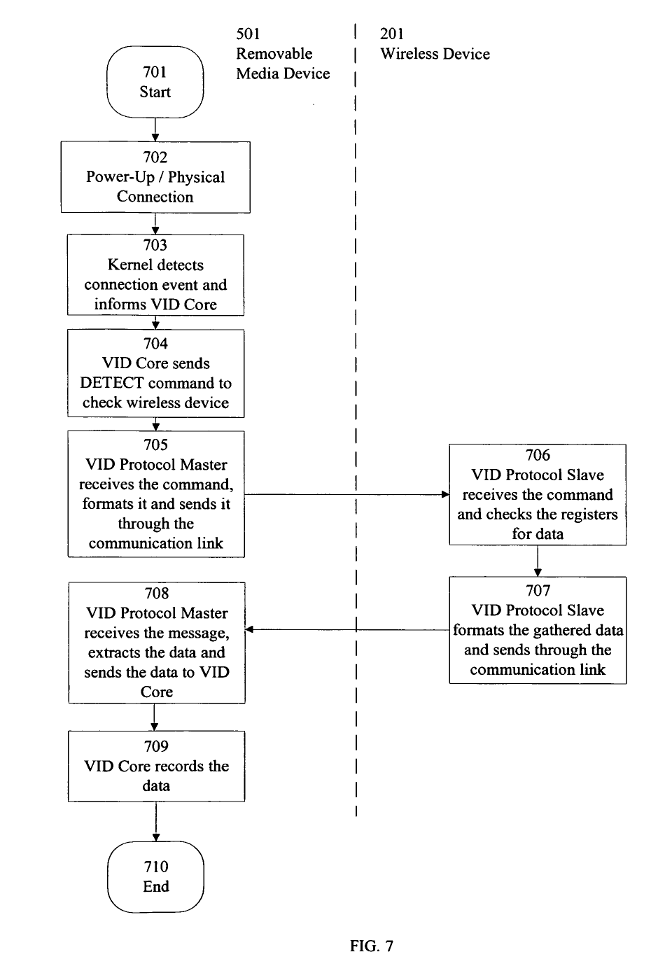

In one aspect, configurable and non-configurable properties of the input device(s) on the wireless device 201 may be detected and communicated between the wireless device 201 and the removable media device 501 which may allow for proper initialization of the input device(s) and proper initialization of removable media device applications 103 that will utilize the input device(s), and may avoid unnecessary configuration steps that could bring the system into an unusable state. FIG. 7 illustrates a flowchart of the procedure below, detailing the detection of configurable properties such as but not limited to thresholds, min values, max values, character case, and language, of the input device on the wireless device, according to one aspect.

From the start, 701, power-up and connection of the wireless device and removable media device, 702, the removable media device will detect the presence of wireless device and inform the VID Core, 703. The VID Core on the removable media device will then send a query message on the presence of the input device(s) in the attached wireless device and its configurable and non-configurable properties, 704. The VID Protocol Master sends this query message as a control signal to the wireless device through the communication link, 705. The VID Protocol Slave on the wireless device then reads its registry either in memory or in its registers for the required information, 706 and returns it to the removable media device through the communication link, 707. The VID Protocol Master then receives the information and returns it to the VID Core, 708. The VID Core then records the properties from which the system and the applications can refer to in configuration stages, 709, ending the process, 710.

### Run-Time Configuration

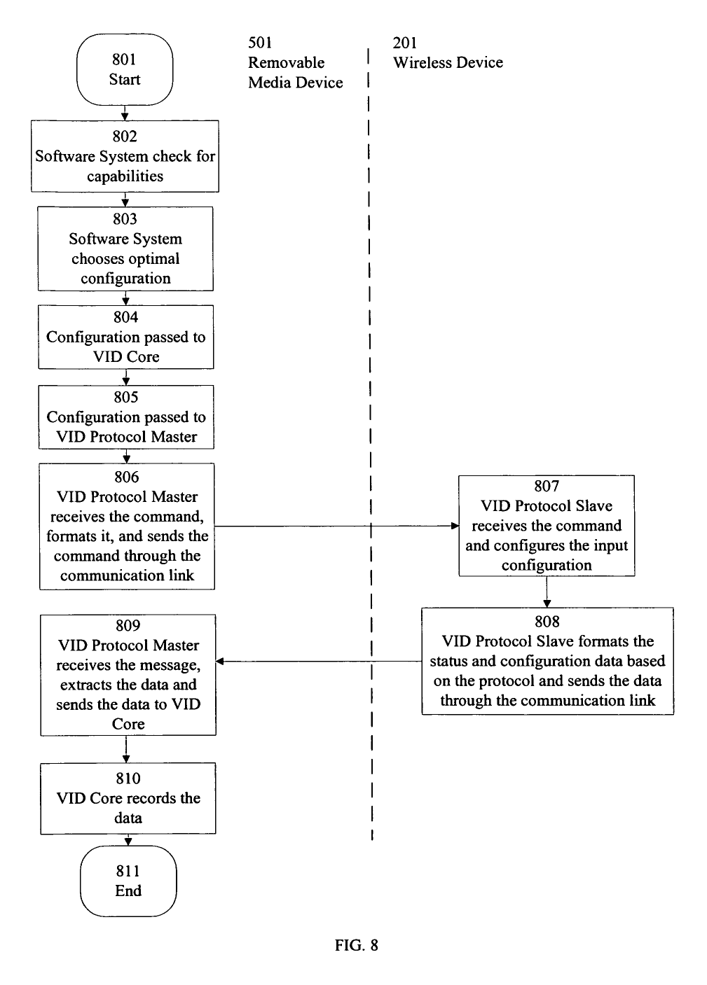

Another aspect allows for run-time configuration of the input device(s) properties. Run-time configuration may refer to the software system or software stack in the removable media device. Further aspects may allow for immediate change on the input device(s) properties to better suit the operating mode of the system. In other aspects, applications 103 may change the input device(s) settings to better fit their specific application 103 in the most optimal way. In another aspect, an application 103 may determine what result is “optimal,” for example a game application would desire the refresh rate of the data to be faster when compared to a document editing application. FIG. 8 illustrates a flowchart of the procedure below, detailing run-time configuration of the input device properties according to one aspect.

To start, 801, the software system in the removable media device may check the capabilities of the input device(s) by referring to the recorded configurable and non-configurable properties of the input device using the recorded properties, 802. Checking the capabilities of the input device(s) may include checking the modes each input device may support. The software system in the removable media device may choose the input device properties for an optimal result, 803. While starting up, the VID Core may chooses the input device(s) properties as a default startup configuration. At run-time, it may be the application that chooses the input device configuration. If at run time, the chosen configuration may be passed to the VID Core from the application through the VID Device Driver using the kernel API provided, 804. The VID Core may forward the request as a control signal to the VID Protocol Master, 805 which then may send the request to the wireless device over the communication link, 806. The VID Slave on the wireless device may then process the request and may configure the input device(s), 807. The VID Slave on the wireless device may then send the result of the operation including success or failure and the resulting configuration properties to the wireless media device over the communication link, 808. The VID Protocol Master may then receive the information and return the information to the VID Core, 809. The VID Core may then record the current configuration properties, 810, from which the software system in the removable media device and the applications may refer to later, ending the process, 811.

### Input Device Event Data Transfers

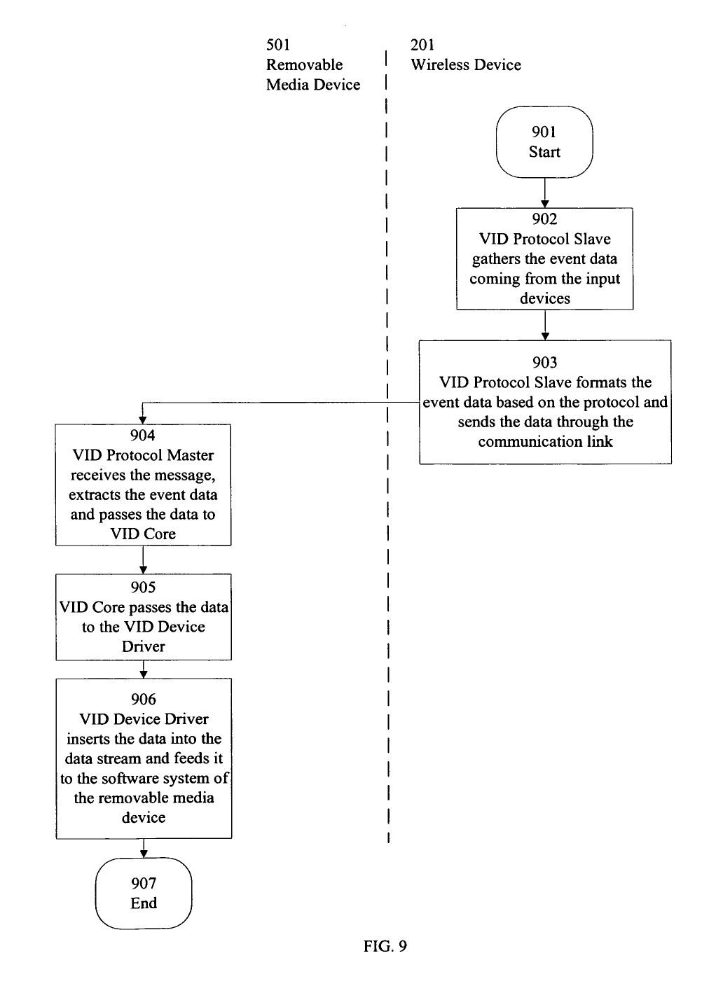

This feature may allow the system to emulate the existence of input device(s) and thereby allow the applications 103 to use the remote physical input device(s) as if the physical device(s) are located in the removable media device 501. An event may be what happens to the input device, such as a button being pressed and released, a stylus moved or lifted, or a finger contacting a touch screen. Event data may be the actual data or character code for the button or the coordinates for a stylus or touch screen. The VID Device Driver 505 is a device driver element which may report the presence of input device(s) to the OS 106 of removable media device 201. The VID Device Driver 505 may also offer the interfaces that a regular input device(s) offers to the software system in the removable media device 501. FIG. 9 illustrates a flowchart of the procedure below, detailing the process of transferring input device event data from the removable media device to the wireless device according to one aspect.

To start, 910, the VID Protocol Slave may gather input device event data from the physical devices present on the wireless device, 902. The VID Protocol Slave then may package the data into VID Protocol Packet(s) and then may send them over the communication link, 903. The VID Protocol Master may then receive the event data and may pass the event data to the VID Core, 904. The VID Core may then pass the event data to the VID Device Driver, 905. The VID Device Driver may then pass the event data to the OS which will finally interpret and process the input device event data, 906, ending the process, 907.

### Protocol Format for Packets Between the Wireless Device and the Removable Media Device

As mentioned, data packets may be transferred to and from the wireless device 201 and removable media device 501 while the VID protocol master 507 and slave 203 are communicating with one another. The following are descriptions of examples of protocols that may be used during this communication process:
Protocol Packet=[Protocol Header Guard] Protocol Header, Body Content, [Protocol Trailer Guard]
Protocol Header=Protocol ID, Packet/Body Information
Body Content=(at least 1 of) [Command(s)] [Result(s)] [Data Payload(s)]
Protocol Header Guard=Information on the beginning of the packet to allow separation between packets
Protocol ID=Unique sequence of bytes that gives very high probability of identifying a real packets together with the Protocol Header Guard and the Protocol Trailer Guard
Packet/Body Information=Gives information on the whole packet and/or body such as, but not limited to, sequence number, size, type, interpretation method
Command=Information blocks for sending control signals between VID Protocol Master and VID Protocol Slave
Result=Information blocks for sending event data and results between VID Protocol Master and VID Protocol Slave
Notify=Information blocks for sending event notifications to allow the slave to transfer data without polling
Data Payload=Information blocks for sending data between VID Protocol Master and VID Protocol Slave such as, but not limited to, input data and current configuration
API's Between VID Protocol Master and VID Protocol Slave

In certain aspects of the present invention, the VID Protocol Master 507 may communicate with the VID Protocol Slave 203 using certain instructions, commands and results codes. As mentioned above, for instance, the VID Core 506 may send commands to the VID Protocol Slave 203. The VID Protocol Slave 203 may return the result code for the command based on the current input device information to the VID Core 506. The following are examples of commands and result codes that may be used in implementing one aspect of the present invention:
DETECT=Command for querying properties of the physical input device(s) on the wireless device
SET=Command for setting configuration properties of the physical input device(s) on the wireless device
GET=Command for checking current configuration properties of the physical input device(s) on the wireless device
Notify=Command for sending input device event data from the physical input devices on the wireless device
OK/NOK=Result of the previous command.

Advantages of embodiments of the present invention may include one or more of the following: (1) the cost of handset may be lower and may require shorter development time because the handset only requires implementing the VID Device Driver system with a lower performance processor; (2) the user interface, runtime environment, and applications may not need to be developed for the handset because they may already be implemented in the removable media device.

In one aspect, all the application and data stored in the removable media device is portable and will run on any handset that implement the VID Device Driver system. In further aspects, the user may preserve their applications and data even if when transferring the removable media device to a handset with a different hardware design, as long as the VID Device Driver system is implemented.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them) but only by the scope of claims.

1. A system for operating the input hardware of a wireless device from a media device, the system comprising:
a wireless device, including:
a processor;
a memory coupled to said processor;
input hardware coupled to said processor; and
a protocol slave adapted to run on said memory and said processor,
wherein said protocol slave is adapted to communicate with said input hardware and the media device.

2. The system of claim 1, wherein said protocol slave is adapted to communicate with the media device by a protocol master on the media device.

3. The system of claim 1, wherein said protocol slave is adapted to run a daemon program.

4. The system of claim 1, wherein said protocol slave is adapted to communicate with the media device through a communication link.

5. The system of claim 4, wherein said communication link is a data bus.

6. The system of claim 4, wherein said communication link is wireless.

7. The system of claim 1, wherein said protocol slave is adapted to transmit, to the media device, data corresponding to one or more configuration settings of said input hardware.

8. The system of claim 7, wherein said configuration settings include a setting corresponding to one or more of thresholds, min values, max values, character case, language, sensitivity and power.

9. The system of claim 1, wherein said protocol slave is adapted to receive data from the media device for configuring one or more settings of said input hardware.

10. The system of claim 1, wherein said protocol slave is adapted to receive data from the media device for execution on said input hardware.

11. A system for operating the input hardware of a wireless device from a media device, the system comprising:
a media device, including:
a first memory;
a processor coupled to said first memory; and
a protocol master adapted to run on said processor and first memory,
wherein said protocol master is adapted to communicate with the input hardware of the wireless device.

12. The system of claim 11, wherein said media device is removably coupled to the wireless device.

13. The system of claim 11, wherein said media device is mechanically connected to the wireless device.

14. The system of claim 11, wherein said media device adheres to a SIM, SAM, SD, micro SD, or USB dongle form factor.

15. The system of claim 11, wherein said media device is a removable media card.

16. The system of claim 11, wherein said first memory is RAM.

17. The system of claim 16, wherein said media device includes a second memory, and wherein said second memory is ROM.

18. The system of claim 11, wherein said protocol master is adapted to communicate with the input hardware of the wireless device through a communication link.

19. The system of claim 18, wherein said communication link is a data bus.

20. The system of claim 18, wherein said communication link is wireless.

21. The system of claim 11, wherein said processor is adapted to run an embedded operating system.

22. The system of claim 21, wherein said embedded operating system is Linux, Win CE, or Symbian.

23. The system of claim 11, wherein said processor is adapted to run an embedded graphics engine for providing a graphical user interface.

24. The system of claim 23, wherein said embedded graphics engine is X-Windows.

25. The system of claim 11, wherein said processor is adapted to run an embedded runtime environment.

26. The system of claim 25, wherein said runtime environment is MatchBox, Android, QT, MontaVista, or Openmoko.

27. The system of claim 11, wherein said protocol master is adapted to communicate with a protocol slave of the wireless device.

28. The system of claim 11, wherein said protocol master is adapted to run a daemon program.

29. The system of claim 11, wherein said protocol master is adapted to communicate with the input hardware of the wireless device using an application layer protocol.

30. The system of claim 11, wherein said protocol master is adapted to communicate with the input hardware of the wireless device using a virtual input device driver layer protocol.

31. The system of claim 11, wherein said media device includes a virtual input device core for emulating the input hardware of the wireless device.

32. The system of claim 11, wherein said protocol master is adapted to transmit input hardware data for execution on the input hardware of the wireless device.

33. The system of claim 11, wherein said protocol master is adapted to transmit data corresponding to one or more input hardware settings for the input hardware of the wireless device to the wireless device.

34. The system of claim 33, wherein said input hardware settings include a setting corresponding to one or more of thresholds, min values, max values, character case, language, sensitivity and power.

35. The system of claim 11, wherein said protocol master is adapted to receive, from the wireless device, data corresponding to one or more configuration settings for the input hardware of the wireless device.

36. The system of claim 35, wherein said configuration settings include a setting corresponding to one or more of thresholds, min values, max values, character case, language, sensitivity and power.

37. The system of claim 11, wherein said protocol master is adapted to communicate with the input hardware of the wireless device by transmitting wrapped packets to the wireless device.

38. The system of claim 37, wherein said wrapped packets further include one or more of a protocol header guard, protocol header, body content, and protocol trailer guard.

39. The system of claim 37, wherein said wrapped packets further include body content, said body content including a data payload corresponding to one or more of input data and configuration.

40. The system of claim 37, wherein said wrapped packets further include a protocol header, said protocol header including body information that identifies one or more of protocol sequence number, size, type, and interpretation method.

41. The system of claim 37, wherein said wrapped packets further include body content, said body content including at least one command, result, or data payload.

42. A system for operating the input hardware of a wireless device from a media device, the system comprising:
a wireless device, including:
a first processor;
a first memory coupled to said first processor;
input hardware coupled to said first processor; and
a protocol slave adapted to run on said first memory and said first processor,
wherein said protocol slave is adapted to communicate with said input hardware;
and a media device, including:
a second memory;
a second processor coupled to said second memory; and
a protocol master adapted to run on said second processor and second memory, wherein said protocol master is adapted to communicate with said protocol slave of said wireless device, and said protocol slave is adapted to communicate with said protocol master of said media device.

43. The system of claim 42, wherein said protocol master is adapted to run a daemon program.

44. The system of claim 42, wherein said protocol slave is adapted to run a daemon program.

45. The system of claim 42, wherein said protocol slave is adapted to communicate with said protocol master through a communication link.

46. The system of claim 45, wherein said communication link is a data bus.

47. The system of claim 45, wherein said communication link is wireless.

48. The system of claim 42, wherein said protocol slave is adapted to transmit, to said protocol master, data corresponding to one or more configuration settings of said input hardware.

49. The system of claim 42, wherein said protocol master is adapted to transmit, to said protocol slave, data corresponding to one or more display settings of said input hardware.

50. The system of claim 49, wherein said display settings correspond to one or more of thresholds, min values, max values, character case, language, sensitivity and power.

51. The system of claim 42, wherein said protocol master is adapted to transmit data to said wireless device for execution on said input hardware.

52. The system of claim 42, wherein said first memory is a buffer memory.

53. The system of claim 42, wherein said wireless device is a cellular telephone.

54. The system of claim 53, wherein said cellular telephone is an OpenMoko Neo FreeRunner.

55. The system of claim 42, wherein said input hardware includes a touch screen.

56. The system of claim 42, wherein said first processor is a baseband processor.

57. The system of claim 42, wherein said wireless device further includes one or more peripheral devices adapted to run on said first processor.

58. The system of claim 57, wherein at least one of said peripheral devices is radio hardware for receiving and transmitting radio signals.

59. The system of claim 58, wherein said radio hardware is adapted to receive or transmit one or more of CDMA, GPRS, GSM, Bluetooth, and Wi-Fi signals.

60. The system of claim 57, wherein at least one of said peripheral devices is adapted to receive input from a user.

61. The system of claim 60, wherein said input represents one or more commands for controlling said input hardware of the wireless device.

62. The system of claim 57, wherein at least one of said peripheral devices includes a keypad, joystick, push button, keyboard, or trackball.

63. The system of claim 57, wherein at least one of said peripheral devices includes an audio codec.

64. The system of claim 57, wherein at least one of said peripheral devices includes a wireless network adapter.

65. The system of claim 42, wherein said wireless device further includes a hardware configuration module for storing data corresponding to input hardware settings for said input hardware.

66. The system of claim 42, wherein said media device is removably coupled to the wireless device.

67. The system of claim 42, wherein said media device is mechanically connected to the wireless device.

68. The system of claim 42, wherein said media device adheres to a SIM, SAM, SD, micro SD, or USB dongle form factor.

69. The system of claim 42, wherein said media device is a removable media card.

70. The system of claim 42, wherein said second memory is RAM.

71. The system of claim 70, wherein said media device includes a third memory, and wherein said third memory is ROM.

72. The system of claim 42, wherein said second processor is adapted to run an embedded operating system.

73. The system of claim 72, wherein said embedded operating system is Linux, Win CE, or Symbian.

74. The system of claim 42, wherein said second processor is adapted to run an embedded graphics engine for providing a graphical user interface.

75. The system of claim 74, wherein said embedded graphics engine is X-Windows.

76. The system of claim 42, wherein said second processor is adapted to run an embedded runtime environment.

77. The system of claim 76, wherein said runtime environment is MatchBox, Android, QT, MontaVista, or Openmoko.

78. The system of claim 42, wherein said protocol master is adapted to communicate with said protocol slave using an application layer protocol.

79. The system of claim 42, wherein said protocol master is adapted to communicate with said protocol slave using a virtual input device driver layer protocol.

80. The system of claim 42, wherein said media device includes a virtual input device core.

81. The system of claim 80, wherein said virtual input device core is programmed to emulate a hardware interface for communicating with a runtime environment.

82. The system of claim 42, wherein said protocol master is adapted to communicate with said protocol slave by transmitting wrapped packets to said protocol slave.

83. The system of claim 82, wherein said wrapped packets further include one or more of a protocol header guard, protocol header, body content, and protocol trailer guard.

84. The system of claim 82, wherein said wrapped packets further include body content, said body content including a data payload corresponding to one or more of input data and configuration.

85. The system of claim 82, wherein said wrapped packets further include a protocol header, said protocol header including body information that identifies one or more of protocol sequence number, size, type, and interpretation method.

86. The system of claim 82, wherein said wrapped packets further include body content, said body content including at least one command, result, or data payload.

87. A system for operating the input hardware of a wireless device from a media device, the system comprising:
a wireless device, including:
a means for processing;
a means for storing coupled to said means for processing;
a means for inputting data coupled to said storing means; and
a means for unwrapping hardware commands adapted to run on said means for storing and said means for processing, wherein said means for unwrapping hardware commands is adapted to communicate with said media device and said means for inputting data.

88. A system for operating the input hardware of a wireless device from a media device, the system comprising:
a media device, including:
a means for processing;
a means for storing coupled to said means for processing; and
a means for emulating input hardware adapted to run on said means for storing and said means for processing, wherein said means for emulating input hardware is adapted to communicate with the input hardware of the wireless device.

89. The system of claim 88, wherein said media device is removably coupled to the wireless device.

90. The system of claim 88, wherein said media device is mechanically connected to the wireless device.

91. The system of claim 88, wherein said media device adheres to a SIM, SAM, SD, micro SD, or USB dongle form factor.

92. A system for operating the input hardware of a wireless device from a media device, the system comprising:
a wireless device, including:
a first means for processing;
a first means for storing coupled to said first means for processing;
a means for inputting data coupled to said first processing means; and
a means for unwrapping hardware commands adapted to run on said first storing means and said first processing means, wherein said means for unwrapping hardware commands is adapted to communicate with said means for inputting data;
a media device, including:
a second means for processing;
a second means for storing coupled to said second means for processing; and
a means for emulating said means for inputting data adapted to run on said second storing means and said second processing means, wherein said means for unwrapping hardware commands of the wireless device is adapted to communicate with said means for emulating of the media device, and said means for emulating is adapted to communicate with said means for unwrapping hardware commands.

93. The system of claim 92, wherein said media device is removably coupled to said wireless device.

94. The system of claim 92, wherein said media device is mechanically connected to said wireless device.

95. The system of claim 92, wherein said media device adheres to a SIM, SAM, SD, micro SD, or USB dongle form factor.

96. A method for operating the input hardware of a wireless device from a media device comprising:
a. mapping, on the wireless device, a processor of the media device, via a protocol slave;
b. receiving, on the wireless device, wrapped packets containing input hardware commands from the media device;
c. unwrapping, on the wireless device, said wrapped packets containing input hardware commands; and
d. executing, by the wireless device, said input hardware commands.

97. The method of claim 96, further including the step of communicating, by said protocol slave, with a protocol master of the media device.

98. The method of claim 96, wherein said wrapped packets are received from a protocol master of the media device.

99. The method of claim 96, further including the step of running a daemon program on said protocol slave.

100. The method of claim 97, wherein said communicating step further includes communicating with said protocol master through a communication link.

101. The method of claim 100, wherein said communication link is a data bus.

102. The method of claim 100, wherein said communication link is wireless.

103. The method of claim 96, further including the step of transmitting, from the wireless device to the media device, data corresponding to one or more configuration settings of the input hardware.

104. The method of claim 96, wherein the executing step is performed by the input hardware of the wireless device.

105. A method for operating the input hardware of a wireless device from a media device comprising:
a. emulating, on the media device, a hardware interface for communicating with a runtime environment;
b. mapping, by a protocol master on the media device, the input hardware of the wireless device to said emulated hardware interface so the media device operates as if directly connected to the input hardware;
c. wrapping, by said protocol master on the media device, input hardware commands into packets;
d. transmitting, by said protocol master on the media device, said wrapped packets containing said input hardware commands to the wireless device; and
e. executing commands, by the media device, as if the input hardware of the wireless device is directly connected to the media device.

106. The method of claim 105, wherein the media device is removably coupled to the wireless device.

107. The method of claim 105, wherein the media device is mechanically connected to the wireless device.

108. The method of claim 105, wherein the media device adheres to a SIM, SAM, SD, micro SD, or USB dongle form factor.

109. The method of claim 105, wherein the media device is a removable media card.

110. The method of claim 105, further including the step of communicating with the input hardware of the wireless device through a communication link.

111. The method of claim 110, wherein the communicating step further includes communicating via said protocol master with a protocol slave of the wireless device.

112. The method of claim 110, wherein the communication link is a data bus.

113. The method of claim 110, wherein the communication link is wireless.

114. The method of claim 105, further including the step of running a daemon program on said protocol master.

115. The method of claim 110, wherein the communicating step further includes communicating with the input hardware of the wireless device using an application layer protocol.

116. The method of claim 110, wherein the communicating step further includes communicating with the input hardware of the wireless device using a virtual input device driver layer protocol.

117. The method of claim 105, wherein said protocol master is implemented by an ASIC programmed to communicate with an ASIC of the wireless device.

118. The system of claim 105, wherein the emulating step is performed by a virtual input device core.

119. The method of claim 105, further including the step of transmitting, from the media device to the wireless device, one or more input hardware settings for the input hardware of the wireless device.

120. The method of claim 119, wherein said input hardware settings include a setting corresponding to one or more of thresholds, min values, max values, character case, language, sensitivity and power.

121. The method of claim 105, further including the step of transmitting, from the media device to the wireless device, input hardware data to be executed on the input hardware.

122. The method of claim 105, wherein said input hardware commands include one or more of querying configurable and non-configurable properties of the input hardware on the wireless device, changing configuration settings for the input hardware, and checking configuration settings of the input hardware.

123. The method of claim 105, wherein the executing step is performed by a processor of the media device.

124. The method of claim 105, wherein said wrapped packets further include one or more of a protocol header guard, protocol header, body content, and protocol trailer guard.

125. The method of claim 105, wherein said wrapped packets further include body content, said body content including a data payload corresponding to one or more of input data and configuration.

126. The method of claim 105, wherein said wrapped packets further include a protocol header, said protocol header including body information that identifies one or more of protocol sequence number, size, type, and interpretation method.

127. The method of claim 105, wherein said wrapped packets further include body content, said body content including at least one command, result, or data payload.

128. A method for operating the input hardware of a wireless device from a media device comprising:
a. emulating, on the media device, a hardware interface for communicating with a runtime environment;
b. mapping, by a protocol master of the media device, the input hardware of the wireless device to said emulated hardware interface so the media device operates as if directly connected to input hardware;
c. mapping, by a protocol slave of the wireless device, a processor of the media device to the input hardware so the input hardware operates as if directly connected to said processor;
d. sending, by said protocol master, wrapped packets containing input hardware commands to said protocol slave of the wireless device;
e. receiving, by said protocol slave, said wrapped packets containing input hardware commands from said protocol master;
f. unwrapping, on the wireless device, said wrapped packets containing input hardware commands; and
g. executing, by the wireless device, said input hardware commands.

129. The method of claim 128, further including the step of running a daemon program on said protocol master.

130. The method of claim 128, further including the step of running a daemon program on said protocol slave.

131. The method of claim 128, wherein said wrapped input hardware commands are sent from said protocol master to said protocol slave via a communication link.

132. The method of claim 131, wherein said communication link is a data bus.

133. The method of claim 131, wherein said communication link is wireless.

134. The method of claim 128, wherein said media device is removably coupled to the wireless device.

135. The method of claim 128, wherein said media device is mechanically connected to the wireless device.

136. The method of claim 128, wherein said media device adheres to a SIM, SAM, SD, micro SD, or USB dongle form factor.

137. The method of claim 128, wherein said media device is a removable media card.

138. The method of claim 128, further including the step of communicating between said protocol slave and said protocol master using an application layer protocol.

139. The method of claim 128, further including the step of communicating between said protocol slave and said protocol master using a virtual input device driver layer protocol.

140. The method of claim 128, further including the step of transmitting, from the wireless device to the media device, data corresponding to one or more configuration settings of the input hardware.

141. The method of claim 128, further including the step of transmitting, from the media device to the wireless device, one or more input hardware settings for the input hardware of the wireless device.

142. The method of claim 141, wherein said input hardware settings include a setting corresponding to one or more of thresholds, min values, max values, character case, language, sensitivity and power.

143. The method of claim 128, further including the step of transmitting, from the media device to the wireless device, input hardware data to be executed on the input hardware.

144. The method of claim 128, wherein said input hardware commands include one or more of querying configurable and non-configurable properties of the input hardware on the wireless device, changing configuration settings for the input hardware, and checking configuration settings of the input hardware.

145. The method of claim 128, wherein the executing step is performed by the input hardware of the wireless device.

146. The method of claim 128, wherein the executing step further includes executing said input hardware commands on the media device as if the input hardware of the wireless device is directly connected to the media device.

147. The method of claim 128, wherein said wrapped packets further include one or more of a protocol header guard, protocol header, body content, and protocol trailer guard.

148. The method of claim 128, wherein said wrapped packets further include body content, said body content including a data payload corresponding to one or more of input data and configuration.

149. The method of claim 128, wherein said wrapped packets further include a protocol header, said protocol header including body information that identifies one or more of protocol sequence number, size, type, and interpretation method.

150. The method of claim 128, wherein said wrapped packets further include body content, said body content including at least one command, result, or data payload.
